(19) United States
(12) Patent Application Publication
(10) Pub. No.: US 2023/0191372 A1
(43) Pub. Date: Jun. 22, 2023

(54) CATALYST FOR PARTICULATE COMBUSTION IN GASOLINE EMISSION TREATMENT SYSTEMS

(71) Applicant: BASF CORPORATION, Florham Park, NJ (US)

(72) Inventors: Karifala DUMBUYA, Hannover (DE); Thomas SCHMITZ, Hannover (DE); Chunxin JI, Iselin, NJ (US); Florian WALTZ, Hannover (DE); Stephan SIEMUND, Hannover (DE); Holger SCHWEKENDIEK, Hannover (DE)

(21) Appl. No.: 18/000,306

(22) PCT Filed: Jun. 30, 2021
(86) PCT No.: PCT/US2021/039804

§ 371 Date: Nov. 30, 2022

(30) Foreign Application Priority Data
Jul. 3, 2020 (EP) 20184000.6

(51) Int. Cl. B01J 23/889; B01J 37/02; B01D 53/94; B01J 6/00; B01J 37/03; B01J 35/02; B01J 35/10; F01N 3/022; F01N 3/10

(52) U.S. Cl. CPC B01J 23/8892; B01J 37/0201; B01J 37/0215; B01D 53/945; B01J 37/0236; B01J 6/001; B01J 37/038; B01J 35/023; B01J 35/1019; F01N 3/0222; F01N 3/101; B01J 35/1014

(57) ABSTRACT

Disclosed herein is a catalyst for particulate combustion which is essentially free of platinum group metal compounds and the catalyst comprises a carrier and at least one metal oxide chosen from iron oxide and manganese oxide, and combinations thereof.

This application claims priority to European Patent Application No. 20184000.6, filed Jul. 3, 2020; the contents of which is incorporated herein by reference in its entirety. The present disclosure relates to a catalyst for particulate combustion in gasoline emission treatment systems and methods for their manufacture. In some embodiments, the catalyst is coated onto a gasoline particulate filter to oxidize particulate trapped in the filter.

Particulate emissions for gasoline engines are subject to regulations including Euro 6 (2014) standards. Some gasoline direct injection engines result in the formation of fine particulates. Gasoline emission treatment systems need to achieve particulate standards. In contrast to particulates generated by diesel lean burning engines, gasoline engines tend to produce finer particulates and in lesser quantities. This is due to the different combustion conditions of a diesel engine compared to a gasoline engine. For example, gasoline engines run at a higher temperature than diesel engines. Also, hydrocarbon components are different in the emissions of gasoline engines compared to emissions of diesel engines.

Emissions of unburned hydrocarbons, carbon monoxide and nitrogen oxide contaminants continue to be regulated. Catalytic converters containing a three-way conversion catalyst (TWC) are accordingly located in the exhaust gas line of internal combustion engines. Such catalysts promote the oxidation by oxygen in the exhaust gas stream of unburned hydrocarbons and carbon monoxide as well as the reduction of nitrogen oxides to nitrogen.

Exhaust gases from a gasoline engine may be passed through a gasoline particulate filter (GPF) coated with a catalyst washcoat to remove particulate before the exhaust gases are emitted into the atmosphere.

For example, U.S. Pat. No. 8,173,087 provides TWC catalysts or oxidation catalysts, coated onto particulate traps such as soot filters. More specifically, it is directed to a soot filter having a catalytic material prepared using two coats: an inlet coat and an outlet coat. The TWC catalyst composite contains palladium and rhodium or platinum and palladium.

Additionally, for example, U.S. Pat. No. 7,977,275 relates to a particulate filter having a catalytic coating which contains two catalysts arranged one behind the other. The first catalyst is located in the gas inlet region of the filter and contains a palladium/platinum catalyst, the second catalyst is arranged downstream of the first catalyst and, in some embodiments, contains platinum alone as catalytically active component, which provides a combination of platinum and palladium to provide optimum properties in terms of resistance to ageing and sulphur poisoning.

However, using a platinum group metal (PGM) like platinum and/or palladium significantly increases the cost of the catalyst. Therefore, it is desirable to provide a catalyst that removes particulate from the gasoline emission which is essentially free of PGM while achieving similar performance to PGM containing catalysts.

Interestingly, within the framework of this disclosure, catalysts essentially free of PGM and comprising at least one metal oxide chosen from iron oxide, manganese oxide and a mixture thereof have particularly similar, or even favorable properties in removing particulate from the exhaust stream compared with conventional PGM containing catalyst.

In some embodiments, the disclosure provides a catalyst essentially free of PGM to remove particulate from gasoline emissions.

In some embodiments, the disclosure provides a catalyst essentially free of PGM to oxidize and remove particulate from the gasoline emission. In some embodiments, the disclosure provides a process for preparing the catalyst of the present disclosure coated on a GPF.

In some embodiments, the disclosure provides a particulate filter comprising the catalyst of the present disclosure.

In some embodiments, the disclosure provides a gasoline engine exhaust gas purification system comprising the particulate filter of the present disclosure.

### BRIEF DESCRIPTION OF THE FIGURES

FIG. 1 shows the particulate oxidation activities (oxygen Pre and Tailpipe) of Example 1 after soot loading (Diesel soot, 4.5 g/L) using a diesel particle generator (DPG) and engine testing using the drop-to-idle (DTI) test protocol at inlet trigger temperatures of 500, 550, 600 and 650° C. on a gasoline engine.

FIG. 2 shows the particulate oxidation activities (oxygen Pre and Tailpipe) of Example 2 after soot loading (Diesel soot, 4 g/L) using a DPG and engine testing using the DTI test protocol at inlet trigger temperatures of 500 and 550° C. on a gasoline engine.

FIG. 3 shows the particulate oxidation activities (oxygen Pre and Tailpipe) of Example 3 under fresh and oven-aged (850° C. hydrothermal, 16 hours) conditions after soot loading (Diesel soot, 4 g/L) using a DPG and engine testing using the DTI test protocol at inlet trigger temperatures of 500° C. on a gasoline engine.

FIG. 4 shows the particulate oxidation activities (oxygen Pre and Tailpipe) of Example 4 after soot loading (Diesel soot, 3.5 g/L) using a DPG and engine testing using the DTI test protocol at inlet trigger temperatures of 500 and 550° C. for fresh catalyst and at inlet trigger temperatures of 550° C. and 600° C. for oven-aged (850° C. hydrothermal, 16 hours) catalyst on a gasoline engine.

FIG. 5 shows the particulate oxidation activities (oxygen Pre and Tailpipe) of Example 5 after soot loading (Gasoline soot, 3.6 g/L) using a 21 Turbo Gasoline Direct Injection (TGDI) engine followed by DTI test protocol at inlet trigger temperatures of 600° C. and 650° C. on another 21 TGDI gasoline engine.

FIG. 6 shows the particulate oxidation activities (oxygen Pre and Tailpipe) of Example 6 after soot loading (Gasoline soot, 4.3 g/L) using a 21 TGDI engine followed by DTI test protocol at inlet trigger temperatures of 600° C. and 650° C. on another 21 TGDI gasoline engine.

The following terms, used in the present description and the appended claims, have the following definitions:

Expressions “a”, “an”, “the”, when used to define a term, include both the plural and singular forms of the term.

All percentages and ratios are mentioned by weight unless otherwise indicated.

As used herein, the term “D90” refers to the diameter at which 90% of particles in a population of particles have a smaller diameter.

As used herein, the term “about” means ±5% of the recited value inclusive of end points and the recited value.

As used herein, the term “TWC” refers to a three-way catalyst that can substantially eliminate HC, CO and NOₓ from gasoline engine exhaust gases. In some embodiments, a TWC essentially consists of one or more platinum-group metals (PGMs), alumina as support material, and cerium-zirconium oxide as both an oxygen storage component and a support material coated on ceramic or metallic substrate.

As used herein, the term “GPF” refers to a gasoline particulate filter.

As used herein, the term “PGM” refers to platinum group metal, while “Pt” refers to platinum, “Pd” refers to palladium, and “Rh” refers to rhodium. It is to be understood that these terms embrace not only the metallic form of these PGMs, but also any metal oxide forms that are catalytically active for emissions reduction.

In some embodiments, a catalyst is essentially free of PGM and the catalyst comprises a carrier and at least one metal oxide chosen from iron oxide, manganese oxide, and combinations thereof.

In some embodiments, the catalyst comprises about 5 wt. % to about 90 wt. %, 10 wt. % to 80 wt. %, 30 wt. % to 70 wt. %, or 30 wt. % to 60 wt. % of carrier, based on the calcined weight of the catalyst.

In some embodiments, the catalyst comprises about 0 wt. % to about 95 wt. %, 5 wt. % to 90 wt. %, 10 wt. % to 70 wt. %, or 10 wt. % to 50 wt. % of iron oxide, based on the calcined weight of the catalyst.

In some embodiments, the catalyst comprises about 0 wt. % to 90 wt. %, 0 wt. % to 80 wt. %, 20 wt. % to 60 wt. %, or 30 wt. % to 60 wt. % of manganese oxide, based on the calcined weight of the catalyst.

In some embodiments, the catalyst comprises about 10 wt. % to about 80 wt. % of carrier, about 5 wt. % to about 90 wt. % of iron oxide and about 0 wt. % to about 80 wt. % of manganese oxide, based on the calcined weight of the catalyst.

In some embodiments, the catalyst comprises about 20 wt. % to about 70 wt. % of the carrier, about 10 wt. % to about 70 wt. % of iron oxide and about 20 wt. % to about 60 wt. % of manganese oxide, based on the calcined weight of the catalyst.

In some embodiments, the catalyst comprises about 30 wt. % to about 60 wt. % of the carrier, about 10 wt. % to about 50 wt. % of iron oxide, and about 20 wt. % to about 60 wt. % of manganese oxide, based on the calcined weight of the catalyst.

As used herein, the term “substantially free of PGM” means that PGM are not intentionally added to an amount greater than about 0.5 wt. % of the catalyst material. In some embodiments, the term “substantially free of PGM” means that PGM make up less than about 0.1 wt. % of the catalyst material. In some embodiments, the term “substantially free of PGM” means that PGM make up less than about 0.01 wt. % of the catalyst material.

As used herein, the term “essentially free of PGM” means that PGM are not intentionally added to an amount greater than about 0.5 wt. % of the catalyst material. In some embodiments, the term “essentially free of PGM” means that PGM make up less than about 0.1 wt. % of the catalyst material. In some embodiments, the term “essentially free of PGM” means that PGM make up less than about 0.01 wt. % of the catalyst material.

In some embodiments, a process for preparing the catalyst of the present disclosure, which comprises:
a) providing a washcoat slurry via impregnating the surface of carrier with particles comprising iron oxide and/or manganese oxide, optionally diluting and/or mixing with one or more other components;
b) coating the pores and/or surface of the porous internal walls of a GPF with the washcoat slurry prepared in step a) and optionally dry the coated GPF under a temperature of 100° C. to 150° C.; and
c) calcinating the coated GPF prepared in step b) under a temperature of 300° C. to 500° C., or 350° C. to 450° C.

In some embodiments, a process for preparing the catalyst of the present disclosure, comprises:
a) providing a mixture of carrier and particles comprising iron oxide and/or manganese oxide using a slurry process, optionally mixing with one or more other components;
b) dry coating the channels and/or pores of the porous internal walls of the GPF with jet-milled mixture prepared in step a).

In some embodiments, the carrier in step a) of above processes comprising one or more of materials chosen from alumina, zirconia-alumina, silica-alumina, lanthana, lanthana-alumina, silica-zirconia lanthana, alumina-zirconia-lanthana, titania, zirconia-titania, neodymia, praseodymia, ceria-zirconia, ceria-alumina, baria-ceria-alumina and ceria; or one or more of materials chosen from alumina, zirconia-alumina, ceria, alumina, zirconia-alumina; or alumina.

In some embodiments, the carrier in step a) of above processes is a high surface area carrier, with surface area of 50 m²/g to 500 m²/g, 100 m²/g to 400 m²/g, or 100 m²/g to 200 m²/g

In some embodiments, the processes for preparing the catalyst of the present disclosure in step a) further comprises milling the slurry to reduce the mean particle size of the particles. In specific embodiments, the slurry is milled to reduce the particle size distribution so that the volume-based mean particle size D90 is in the range of about 2 μm to 25 μm, 2 μm to 20 μm, 3 μm to 18 μm, or 3 μm to 16 μm depending on whether in-wall or partial on-wall application is desired.

In some embodiments, a process for preparing the catalyst of the present disclosure, comprises:
a) providing a washcoat slurry via impregnating the surface of carrier with particles comprising iron oxide and/or manganese oxide, optionally diluting and/or mixing with one or more other components;
b) coating the pores and/or surface of the porous internal walls of the GPF with the washcoat slurry prepared in step a) and optionally drying the coated GPF under a temperature ranging from 100° C. -150° C. In some embodiments, the coating is on the surface of the porous internal walls of the outlet of GPF; and
c) calcinating the coated GPF prepared in step b) under a temperature of 300° C. to 500° C., or 350° C. to 450° C.
d) providing a mixture of carrier and particles comprising iron oxide and/or manganese oxide using a slurry process, optionally mixing with one or more other components;
e) dry coating the channels and/or pores of the porous internal walls of the GPF obtained in step c) with jet-milled mixture prepared in step d). In some embodiments, the dry coating is coated in the inlet of the GPF obtained in step c).

In some embodiments, the GPF comprises alternatingly closed channels that force the exhaust gas flow through porous walls, a ceramic wall-flow filter, a wire mesh filter, a ceramic or SiC foam filter, etc. In some embodiments, the GPF is a porous wall flow filter comprising an inlet end, an outlet end, a substrate axial length extending between the inlet end and the outlet end, and a plurality of passages defined by porous internal walls of the porous wall flow filter substrate, wherein the plurality of passages comprise inlet passages having an open inlet end and a closed outlet end, and outlet passages having a closed inlet end and an open outlet end; wherein in the pores of the porous internal walls and on the surface of the porous internal walls, which surface defines the interface between the porous internal walls and the passages. When the catalyst is coated in the pores of the porous internal walls, the catalyst is present as an in-wall coating; and when the catalyst is coated on the surface of the porous internal walls, the catalyst is present as an on-wall coating.

As used herein, the term “the surface of the porous internal walls” is to be understood as the surface of the walls, i.e. the surface of the walls in an untreated state which consists, apart from any unavoidable impurities with which the surface may be contaminated, of the material of the walls.

In some embodiments, the catalyst comprises no further coating in the pores of the porous internal walls and no further coating on the surface of the porous internal walls.

In some embodiments, the GPF has a substantially uniform mean pore size.

As used herein, the term “substantially uniform mean pore size” means that the mean pore size across the wall does not vary by more than a factor of 10.

In some embodiments, the GPF has an average pore size ranging from about 3 μm and about 35 μm, about 5 μm and about 30 μm, about 5 μm and about 25 μm, or about 8 μm and about 22 μm. In some embodiments, the mean pore size is effective to allow build-up of soot on the inlet side of the filter wall. In some further embodiments, the mean pore size is effective to allow some soot to enter the pores on the inlet surface of the porous walls.

In one embodiment, the average porosity of the internal walls of GPF ranges from 20% to 75%, 30% to 70%, or 40% to 65%.

In some embodiments, the catalyst is coated onto a GPF at a loading in the range of at least about 5 g/L, about 10 g/L, about 15 g/L, about 20 g/L, about 25 g/L or about 30 g/L up to about 150 g/L, about 175 g/L, about 200 g/L, about 225 g/L, about 250 g/L about 275 g/L, about 300 g/L or about 325 g/L. It is to be understood that each lower endpoint and each higher endpoint disclosed in the foregoing may be combined to form a catalyst loading range that is expressly contemplated by the disclosure. In certain exemplary embodiments, the catalyst loading is in the range of about 20 g/L to 300 g/L, or about 30 g/L to 200 g/L.

In one embodiment, the catalyst is a fresh catalyst, i.e. a catalyst which has not been exposed to a treatment of an exhaust gas stream of a gasoline engine.

In some embodiment, the catalyst is an aged catalyst which has been treated in oven under temperature of about 600° C. to 1050° C., 700° C. to 1050° C., or 800° C. to 1050° C.

In some embodiments, the catalyst is present as an on-wall coating only, an in-wall coating only, or both an on-wall and an in-wall coating. For catalyst present as both an on-wall and an in-wall coating, the loading ratio of on-wall and in-wall coating ranges from 1:99 to 99:1, from 5:95 to 95:5, from 20:80 to 80:20, from 30:70 to 70:30, or from 40:60 to 60:40.

In some embodiments, the porous internal walls of GPF comprising the in-wall coating have a relative average porosity in the range of from 20% to 99%, from 50% to 98%, or from 50% to 75%, wherein the relative average porosity is defined as the average porosity of the internal walls comprising the in-wall coating relative to the average porosity of the internal walls not comprising the in-wall coating.

In some embodiments, the porous internal walls of the GPF comprising the in-wall coating have a relative average pore size in the range of from 3 μm to 30 μm, in the range of from 3 μm to 25 μm, or in the range of from 5 μm to 20 μm.

In some embodiments, the GPF comprises the catalytic coating at an inlet coating length of≤x≤% of the substrate axial length, wherein 0≤x≤100, 50≤x≤100, 75≤x≤100, 90≤x≤100, 95≤x≤100, or 99≤x≤100; and that the wall flow filter substrate comprises the catalytic coating at an outlet coating length of≤y≤% of the substrate axial length, wherein 0≤y≤100, 50≤y≤100, 75≤y≤100, 90≤y≤100, 95≤y≤100, or 99y≤100; wherein x+y>0.

In some embodiments, the GPF comprises the catalytic coating at an inlet coating length of≤x≤% of the substrate axial length, wherein 10≤x≤90, 20≤x≤80, 30≤x≤70, 40≤x≤60, or 45≤x≤55; and that the wall flow filter substrate comprises the catalytic coating at an outlet coating length of y % of the substrate axial length, wherein 10≤y≤90, 20≤y≤80, 30≤y≤70, 40≤y≤60, or 45≤y≤55.

In some embodiments, the catalyst is coated on the inlet channel of the GPF only.

In some embodiments, the calcination temperature in step c) is from 300° C. to 600° C., 300° C. to 500° C., or 350° C. to 450° C. In some embodiments, the calcination period is from 10 minutes to 10 hours, 0.5 hour to 8 hours, or 1 hour to 4 hours.

A In some embodiments, a particulate filter comprises the catalyst.

In some embodiments, a gasoline engine exhaust gas purification system comprises the particulate filer.

In some embodiments, gasoline engine exhaust is passed through a GPF coated with the catalyst at a space velocity of, for example, up to 80,000 hr⁻¹.

In some embodiments, the gasoline engine exhaust gas purification system further comprises at least one TWC. In some embodiments, the TWC is upstream of the particulate

filter. In some embodiments, TWC comprising Pd, Rh and optionally Pt.

The following are additional exemplary embodiments.

1. A catalyst for particulate combustion comprises a carrier and at least one metal oxide chosen from iron oxide, manganese oxide, and combinations thereof, wherein the catalyst is essentially free of platinum group metal compounds.

2. The catalyst for particulate combustion according to embodiment 1, wherein the catalyst comprises from 5 wt. % to 90 wt. %, from 10 wt. % to 80 wt. %, from 30 wt. % to 70 wt. %, or from 30 wt. % to 60 wt. % of the carrier, based on a calcined weight of the catalyst.

3. The catalyst for particulate combustion according to embodiment 1 or 2, wherein the catalyst comprises from 0 wt. % to 95 wt. %, from 5 wt. % to 90 wt. %, from 10 wt. % to 70 wt. %, or 10 wt. % to 50 wt. % iron oxide, based on a calcined weight of the catalyst.

4. The catalyst for particulate combustion according to any one of embodiments 1 to 3, wherein the catalyst comprises from 0 wt. % to 90 wt. %, from 0 wt. % to 80 wt. %, from 20 wt. % to 60 wt. %, or 30 wt. % to 60 wt. % manganese oxide, based on the calcined weight of the catalyst.

5. The catalyst for particulate combustion according to any one of embodiments 1 to 4, wherein the carrier is one or more of materials chosen from alumina, zirconia-alumina, silica-alumina, lanthana, lanthana-alumina, silica-zirconialanthana, alumina-zirconia-lanthana, titania, zirconia-titania, neodymia, praseodymia, ceria-zirconia, ceria-alumina, baria-ceria-alumina and ceria; or one or more of materials chosen from alumina, zirconia-alumina, ceria, alumina, zirconia-alumina; and alumina.

6. The catalyst for particulate combustion according to any one of embodiments 1 to 5, wherein the catalyst comprises from 10 wt. % to 50 wt. % iron oxide, from 30 wt. % to 60 wt. % carrier, and from 20 wt. % to 60 wt. % manganese oxide, based on a calcined weight of the catalyst.

7. The catalyst for particulate combustion according to any one of embodiments 1 to 6, prepared by a process comprising: providing a washcoat slurry via impregnating the surface of the carrier with particles comprising iron oxide and/or manganese oxide, optionally diluting and/or mixing with one or more other components;

coating pores and/or a surface of a porous internal walls of a gasoline particulate filter (GFP) with the washcoat slurry to obtain a coated GFP and optionally drying the coated GPF under a temperature ranging from 100° C. to 150° C.; and calcinating the coated GPF at a temperature ranging from 300° C. to 500° C., or

8. The catalyst for particulate combustion according to any one of embodiments 1 to 6, prepared by a process comprising:

providing a mixture of the carrier and particles comprising iron oxide and/or manganese oxide using a slurry process, optionally mixing with one or more other components; and

dry coating channels and/or pores of a porous internal wall of a gasoline particulate filter (GPF) with the provided mixture to obtain a coated GFP.

9. The catalyst for particulate combustion according to any one of embodiments 1 to 6, prepared by a process comprising:

providing a washcoat slurry via impregnating the surface of the carrier with particles comprising iron oxide and/or manganese oxide, optionally diluting and/or mixing with one or more other components;

coating pores and/or a surface of a porous internal wall of a gasoline particulate filter (GPF) with the provided washcoat slurry to obtain a coated GFP and optionally drying the coated GPF under a temperature ranging from 100° C. to 150° C.;

calcinating the coated GPF under a temperature ranging from 300° C. to 500° C., or 350° C. to 450° C. to obtain a calcined GFP.

providing a mixture of the carrier and particles comprising iron oxide and/or manganese oxide using a slurry process, optionally mixing with one or more other components; and

dry coating channels and/or pores of a porous internal walls of the calcined GPF with the provided mixture, optionally wherein the dry coating is coated in the inlet of the calcined GPF.

10. The catalyst for particulate combustion according to any one of embodiments 7 to 9, wherein the D90 of the particles comprising iron oxide and/or manganese oxide ranges from 2 μm to 20 μm, 2 μm to 18 μm, 3 μm to 15 μm, or 5 μm to 13 μm.

11. The catalyst for particulate combustion according to any one of embodiments 7 to 10, wherein the GPF comprises an inlet end, an outlet end, a substrate axial length extending between the inlet end and the outlet end, and a plurality of passages defined by porous internal walls of the porous wall flow filter substrate, wherein the plurality of passages comprise inlet passages having an open inlet end and a closed outlet end, and outlet passages having a closed inlet end and an open outlet end;

12. The catalyst for particulate combustion according to any one of embodiments 7 to 11, wherein the carrier is one or more of materials chosen from alumina, zirconia-alumina, silica-alumina, lanthana, lanthana-alumina, silica-zirconia lanthana, alumina-zirconia-lanthana, titania, zirconia-titania, neodymia, praseodymia, ceria-zirconia, ceria-alumina, baria-ceria-alumina and ceria; or one or more of materials chosen from alumina, zirconia-alumina, ceria, alumina, zirconia-alumina; and alumina.

13. The catalyst for particulate combustion according to any one of embodiments 1 to 12, wherein the carrier has a surface area ranging from 50 m²/g to 500 m²/g, 100 m²/g to 400 m²/g, or 100 m²/g to 200 m²/g.

14. A particulate filter for filtering out particulate present in the exhaust gases of an internal combustion engine, wherein the particulate filter comprises a catalyst according to any one of embodiments 1 to 13.

15. The particulate filter according to embodiment 14, wherein the catalyst according to any one of embodiments 1 to 12 is coated at the inlet channels of the particulate filter.

16. The particulate filter according to embodiment 14 or 15, wherein the catalyst is coated onto the particulate filter along the whole of its axial length, part of its axial length, the whole of its radial direction, part of its radial direction, alternating channels, on a wall, in a porous wall, or a combination thereof.

17. The particulate filter according to any one of embodiments 14 to 16, wherein the particulate filter comprises a wall-flow filter comprising a honeycomb structure.

18. The particulate filter according to any one of embodiments 14 to 17, wherein the mean pore size of the particulate filter is from 10 μm to 24 μm, or from 14 μm to 20 μm.

19. The particulate filter according to any one of embodiments 14 to 18, wherein the porosity of the particulate filter is from 40% to 65%.

20. The gasoline engine exhaust gas purification system wherein the exhaust gas purification system comprises the particulate filter according to any one of embodiments 14 to 19, and at least one TWC, optionally the TWC is upstream of the particulate filter.

21. The gasoline engine exhaust gas purification system according to embodiment 20, wherein the TWC comprises Pd, Rh, and optionally Pt.

### EXAMPLES

The following examples are provided for illustrative purposes, but by no means are a limitation to the disclosure.

The average porosity of the porous wall-flow substrate was determined by mercury intrusion using mercury porosimeter according to DIN 66133 and ISO 15901-1.

The slurry dynamic viscosities were measured with a HAAKE Rheostress 6000 manufactured by Thermo Fisher Scientific. Values reported here are measured at a shear rate of 300 per second. Viscosity was measured at 20° C.

The D90 particle size distributions were determined by a static light scattering method using Sympatec HELOS (3200) & QUIXEL equipment, wherein the optical concentration of the sample was in the range of from 6 to 10%.

The Filter used in the Examples 1 to 6 are medium to high porosity filters.

### Example 1

Bare filter of Corning LP 1.0 (cylindrically shaped of 6.43 inches×6 inches, 200 cells per square inch, wall thickness of 8 mil; porosity of 55% and mean pore size of 14 μm).

### Example 2

A slurry was prepared by adding alumina having a surface area of 150 m²/g to distilled water and stirring for 10 minutes. Next, manganese oxide was added and the pH was adjusted with diluted nitric acid to a pH ranging from 5 to 6. The prepared mixture was milled at solid content of 38% to have particles with a D90 of 5 μm. Next, the pH was adjusted with diluted nitric acid to a pH ranging from 5 to 6. A high porosity filter, NGK C-810 (cylindrically shaped of 4.66 inches×5 inches, 300 cells per square inch, wall thickness of 8 mil, porosity of 65% and mean pore size of 20 μm), was coated in the pores of the porous internal walls with the slurry washcoat. The coated filter was dried at 120° C. for 2 hours and calcined at 400° C. in an oven to obtain a fresh catalyst with a weight ratio of alumina to manganese oxide of 1:1 and an amount of the dried washcoat of 60 g/L (1 g/in³).

### Example 3

A slurry was prepared by adding alumina having a surface area of 150 m²/g to distilled water and stirring for 10 minutes. Next, manganese oxide was added and the pH was adjusted with dilute nitric acid to a pH ranging from 5 to 6. The prepared mixture was milled at a solid content of 38% to have particles with a D90 of 13 μm. Next, the pH was adjusted with diluted nitric acid to a pH ranging from 5 to 6. A medium porosity filter, NGK-C780 (cylindrically shaped of 5.2 inches×4.7 inches, 200 cells per square inch, wall thickness of 8 mil, porosity of 55% and mean pore size of 9 μm), was coated in the pores and on the surface of the porous internal walls with above obtained slurry washcoat. The coated filter was dried at 120° C. for 2 hours and calcined at 400° C. in an oven to obtain a fresh catalyst with a weight ratio of alumina to manganese oxide of 1:1 and an amount the dried washcoat ranging from 30 g/L (0.5 g/in³). The fresh catalyst was further aged at 850° C. for 16 hours to obtain the aged catalyst.

### Example 4

A mixture of alumina having a surface area of 150 m²/g and manganese oxide were jet-milled to achieve a D90 of 8 μm. The jet-milled mixture was applied in a dry coating process to populate the surface of the porous internal walls of a high porosity filter, Corning HP 1.1(cylindrically shaped of 4.66 inches×5 inches, 300 cells per square inch, wall thickness of 8 mil, porosity of 65% and mean pore size of 17 μm), and obtain the fresh catalyst with a weight ratio of alumina to manganese oxide of 1:1 and an amount of the dried washcoat of 15 g/L (0.25 g/in³). The fresh catalyst was further aged at 850° C. for 16 hours to obtain the aged catalyst.

### Example 5

A slurry was prepared by adding alumina having a surface area of 150 m²/g to distilled water with stirring for 10 minutes. Next, iron nitrate nonahydrate crystal was added with stirring for 10 minutes. Next, manganese oxide was added slowly to the alumina-iron nitrate mixture and pH was adjusted with diluted nitric acid to a pH ranging from 5 to 6. The prepared mixture was milled at a solid content of 38% to achieve particles with a D90 of 5 μm. Next, the pH was adjusted with diluted nitric acid to a pH ranging from 5 to 6. A Corning HP 1.1(cylindrically shaped of 4.66 inches×5 inches, 300 cells per square inch, wall thickness of 8 mil, porosity of 65% and mean pore size of 17 μm) was coated in the pores of the porous internal walls with the slurry washcoat. The coated filter was dried at 120° C. for 2 hours, then calcined at 400° C. in an oven to obtain the fresh catalyst with a weight ratio of alumina: manganese oxide: iron oxide of 5:4:1 and an amount of the dried washcoat of 60 g/L (1 g/in³).

### Example 6

A slurry was prepared by adding alumina having a surface area of 150 m²/g to distilled water and stirring for 10 minutes. Next, iron nitrate nonahydrate crystal was added with stirring for 10 minutes, and the pH was adjusted with diluted nitric acid to a pH ranging from 5 to 6. The prepared mixture was milled at solid content of 38% to have the particles with a D90 of 5 μm. Next, the pH was adjusted with diluted nitric acid to a pH ranging from 5 to 6. A Corning HP 1.1 (cylindrically shaped of 4.66 inches×5 inches, 300 cells per square inch, wall thickness of 8 mil, porosity of 65% and mean pore size of 17 μm), was coated in the pores of the porous internal walls with the slurry washcoat. The coated filter was dried at 120° C. for 2 hours, then calcined at 400° C. in an oven to obtain the fresh catalyst with a weight ratio of alumina: iron oxide of 3:1 and an amount of the dried washcoat of 60 g/L (1 g/in³).

Evaluation: Examples 1 to 6 were loaded with soot and evaluated on a diesel particle generator (DPG) or 2 Liter Turbo Gasoline Direct Injection (TGDI) engine running at 2,500 rpm under full duty working conditions.

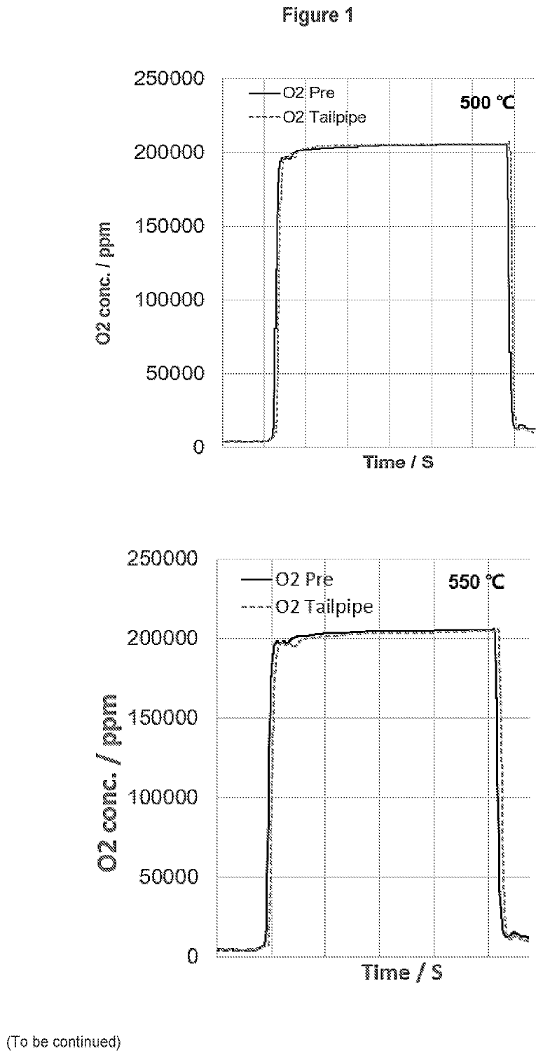

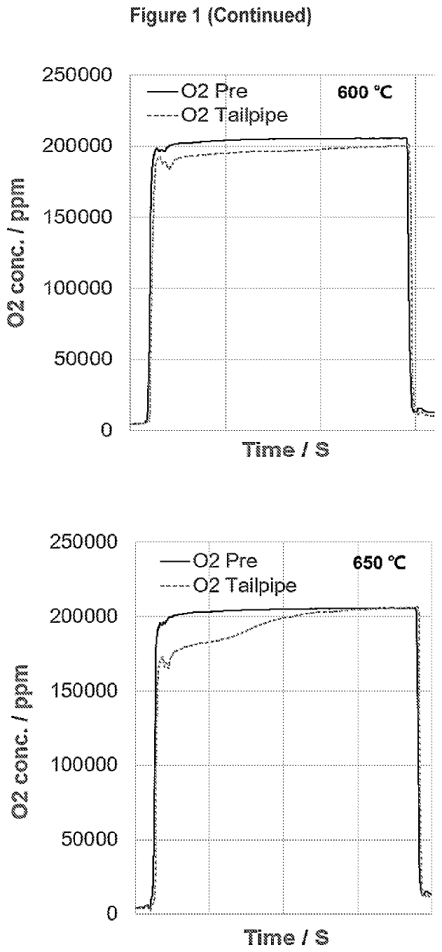

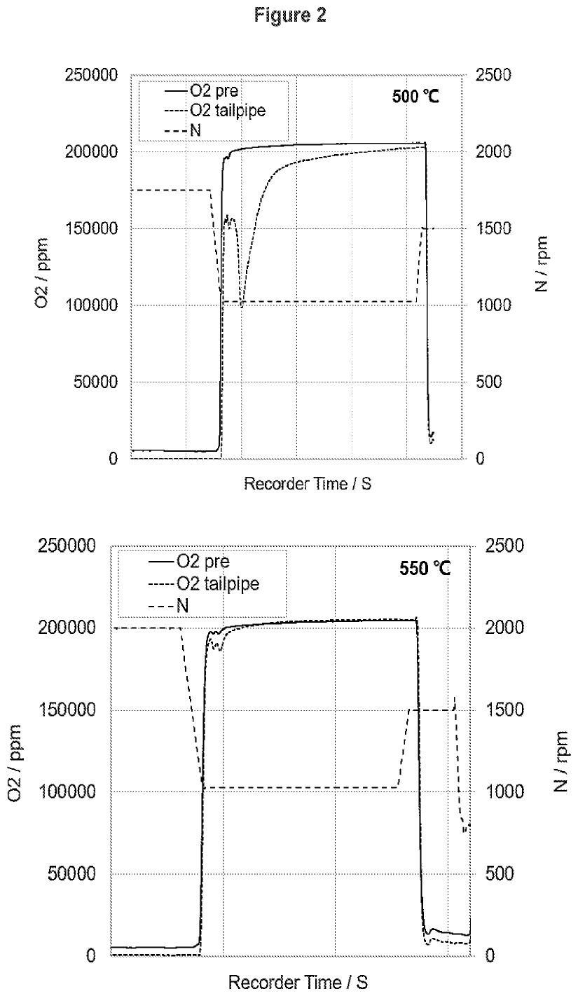

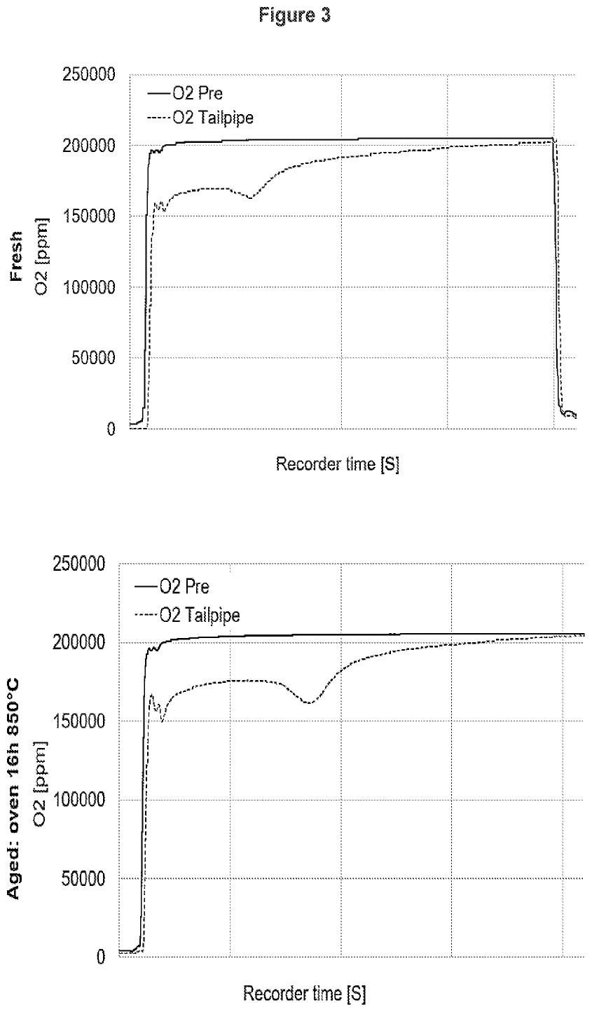

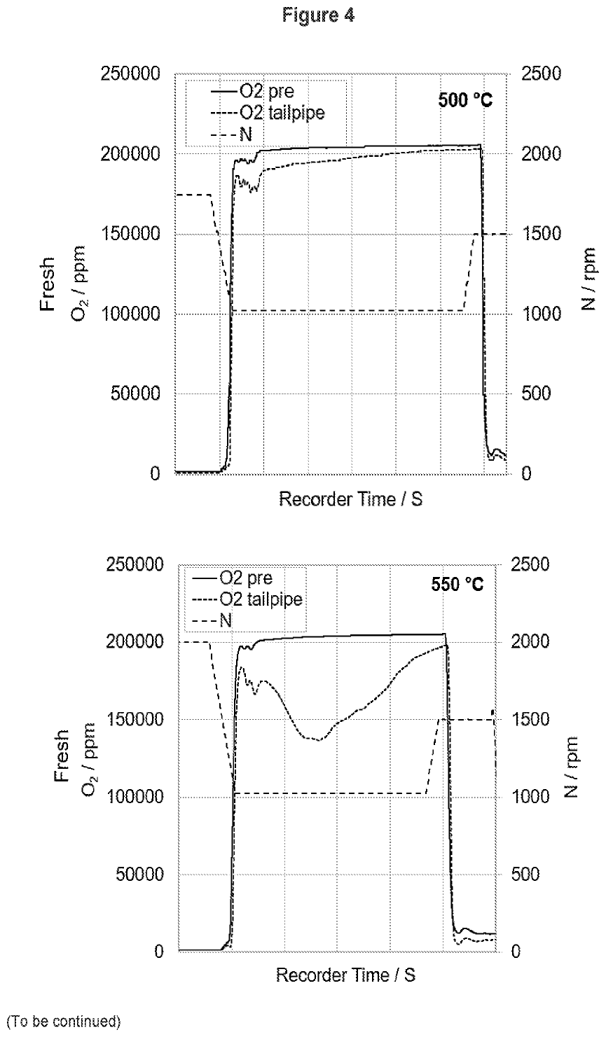

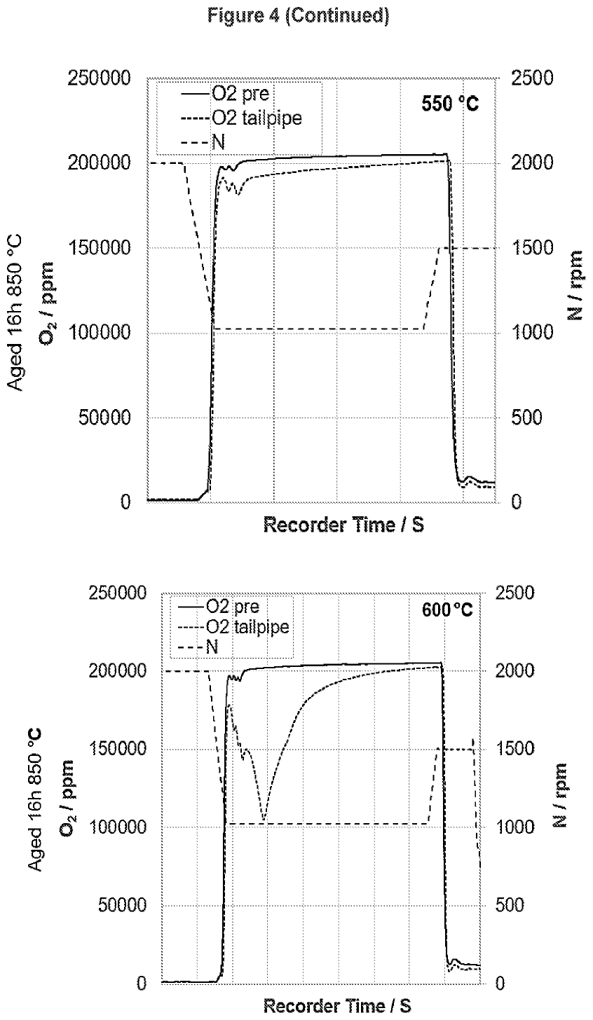

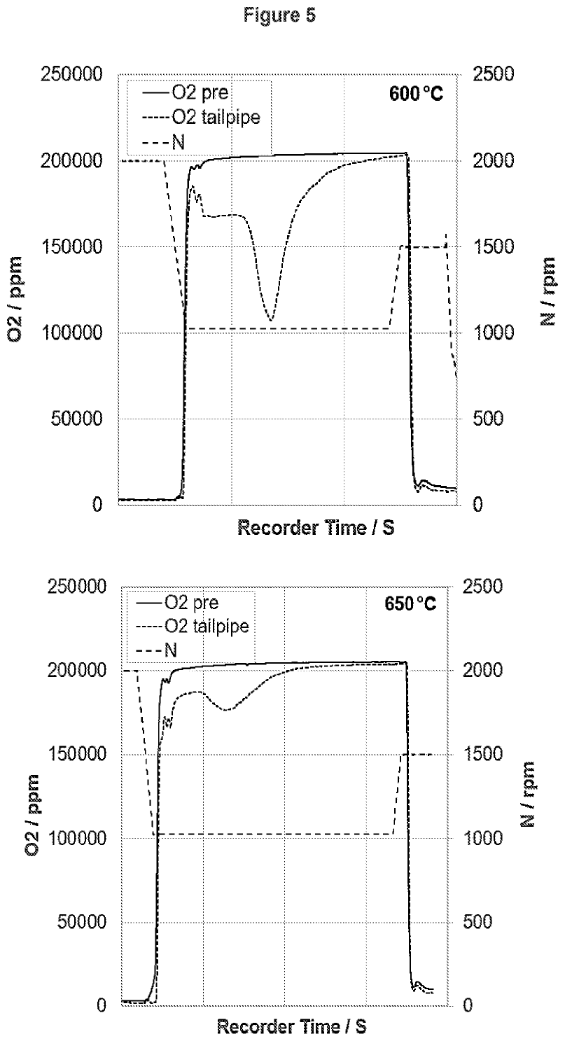

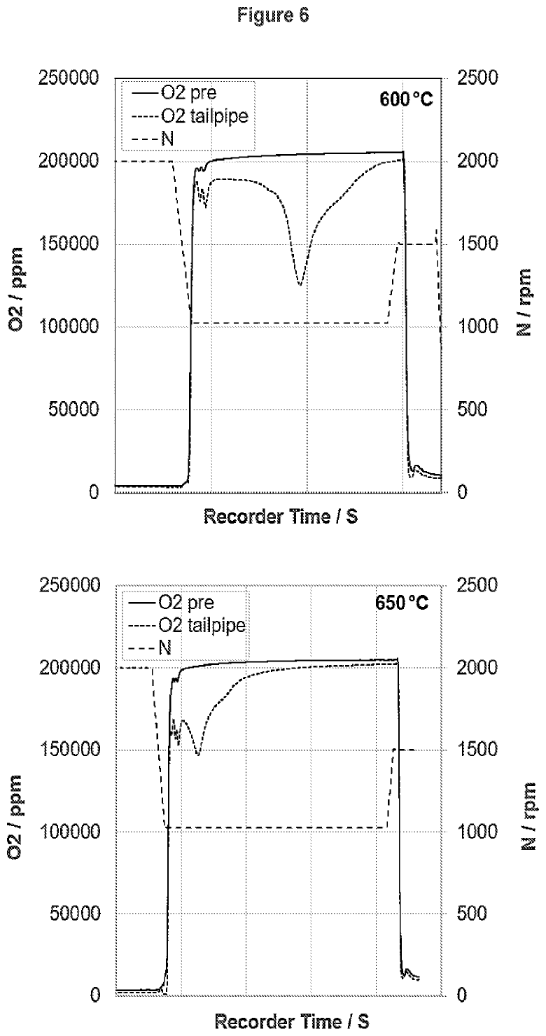

The results of the evaluation are showed in FIGS. 1-6.

1. A catalyst for particulate combustion comprising: a carrier and at least one metal oxide chosen from iron oxide, manganese oxide, and combinations thereof, wherein the catalyst is essentially free of platinum group metal compounds.

2. The catalyst for particulate combustion according to claim 1, wherein the catalyst comprises from 5 wt. % to 90 wt. %, from 10 wt. % to 80 wt. %, from 30 wt. % to 70 wt. %, or from 30 wt. % to 60 wt. % of the carrier, based on a calcined weight of the catalyst.

3. The catalyst for particulate combustion according to claim 1, wherein the catalyst comprises from 0 wt. % to 95 wt. %, from 5 wt. % to 90 wt. %, from 10 wt. % to 70 wt. %, or 10 wt. % to 50 wt. % iron oxide, based on a calcined weight of the catalyst.

4. The catalyst for particulate combustion according to claim 1, wherein the catalyst comprises from 0 wt. % to 90 wt. %, from 0 wt. % to 80 wt. %, from 20 wt. % to 60 wt. %, or 30 wt. % to 60 wt. % manganese oxide, based on the calcined weight of the catalyst.

5. The catalyst for particulate combustion according to claim 1, wherein the carrier is: one or more of materials chosen from alumina, zirconia-alumina, silica-alumina, lanthana, lanthana-alumina, silica-zirconia lanthana, alumina-zirconia-lanthana, titania, zirconia-titania, neodymia, praseodymia, ceria-zirconia, ceria-alumina, baria-ceria-alumina and ceria; or one or more of materials chosen from alumina, zirconia-alumina, ceria, alumina, zirconia-alumina; and alumina.

6. The catalyst for particulate combustion according to claim 1, wherein the catalyst comprises from 10 wt. % to 50 wt. % iron oxide, from 30 wt. % to 60 wt. % carrier, and from 20 wt. % to 60 wt. % manganese oxide, based on a calcined weight of the catalyst.

7. The catalyst for particulate combustion according to claim 1, prepared by a process comprising:
providing a washcoat slurry via impregnating a surface of the carrier with particles comprising iron oxide and/or manganese oxide, optionally diluting and/or mixing with one or more other components;
coating pores and/or a surface of a porous internal walls of a gasoline particulate filter (GFP) with the washcoat slurry to obtain a coated GFP and optionally drying the coated GPF under a temperature ranging from 100° C. to 150° C.; and
calcinating the coated GPF at a temperature ranging from 300° C. to 500° C., or 350° C. to 450° C.

8. The catalyst for particulate combustion according to claim 1, prepared by a process comprising:
providing a mixture of the carrier and particles comprising iron oxide and/or manganese oxide using a slurry process, optionally mixing with one or more other components; and dry coating channels and/or pores of a porous internal wall of a gasoline particulate filter (GPF) with the provided mixture to obtain a coated GFP.

9. The catalyst for particulate combustion according to claim 1, prepared by a process comprising:
providing a washcoat slurry via impregnating the surface of the carrier with particles comprising iron oxide and/or manganese oxide, optionally diluting and/or mixing with one or more other components;
coating pores and/or a surface of a porous internal wall of a gasoline particulate filter (GPF) with the provided washcoat slurry to obtain a coated GFP and optionally drying the coated GPF under a temperature ranging from 100° C. to 150° C.;
calcinating the coated GPF under a temperature ranging from 30 0° C. to 500° C., or 350° C. to 450° C. to obtain a calcined GFP;
providing a mixture of the carrier and particles comprising iron oxide and/or manganese oxide using a slurry process, optionally mixing with one or more other components; and
dry coating channels and/or pores of a porous internal walls of the calcined GPF with the provided mixture, optionally wherein the dry coating is coated in the inlet of the calcined GPF.

10. The catalyst for particulate combustion according to claim 1, wherein the D90 of the particles comprising iron oxide and/or manganese oxide ranges from 2 μm to 20 μm, 2 μm to 18 μm, 3 μm to 15 μm, or 5 μm to 13 μm.

11. The catalyst for particulate combustion according to claim 7, wherein the GPF comprises an inlet end, an outlet end, a substrate axial length extending between the inlet end and the outlet end, and a plurality of passages defined by porous internal walls of the porous wall flow filter substrate, wherein the plurality of passages comprise inlet passages having an open inlet end and a closed outlet end, and outlet passages having a closed inlet end and an open outlet end.

12. The catalyst for particulate combustion according to claim 7, wherein the carrier is: one or more of materials chosen from alumina, zirconia-alumina, silica-alumina, lanthana, lanthana-alumina, silica-zirconia lanthana, alumina-zirconia-lanthana, titania, zirconia-titania, neodymia, praseodymia, ceria-zirconia, ceria-alumina, baria-ceria-alumina and ceria; or one or more of materials chosen from alumina, zirconia-alumina, ceria, alumina, zirconia-alumina; and alumina.

13. The catalyst for particulate combustion according to claim 1, wherein the carrier has a surface area ranging from 50 m²/g to 500 m²/g, 100 m²/g to 400 m²/g, or 100 m²/g to 200 m²/g.

14. A particulate filter for filtering out particulate present in the exhaust gases of an internal combustion engine, wherein the particulate filter comprises a catalyst according to claim 1.

15. The particulate filter according to claim 14, wherein the catalyst according to claim 1 is coated at the inlet channels of the particulate filter.

16. The particulate filter according to claim 14, wherein the catalyst is coated onto the particulate filter along the whole of its axial length, part of its axial length, the whole of its radial direction, part of its radial direction, alternating channels, on a wall, in a porous wall, or a combination thereof.

17. The particulate filter according to claim 14, wherein the particulate filter comprises a wall-flow filter comprising a honeycomb structure.

18. The particulate filter according to claim 14, wherein the mean pore size of the particulate filter ranges from 10 μm to 24 μm, or from 14 μm to 20 μm.

19. The particulate filter according to claim 14, wherein the porosity of the particulate filter ranges from 40% to 65%.

20. A gasoline engine exhaust gas purification system, wherein the exhaust gas purification system comprises the particulate filter according to claim 14, and at least one TWC, wherein optionally, the TWC is upstream of the particulate filter.

21. The gasoline engine exhaust gas purification system according to claim 20, wherein the TWC comprises palladium, rhodium, and optionally platinum.
